(19) United States
(12) Patent Application Publication
(10) Pub. No.: US 2016/0140659 A1
(43) Pub. Date: May 19, 2016

(54) METHOD FOR CREATING A SECONDARY MARKET FOR NON-PUBLICALLY TRADED PRIVATELY PLACED SECURITIES

(71) Applicant: Anthony J. Zeoli, Chicago, IL (US)

(72) Inventor: Anthony J. Zeoli, Chicago, IL (US)

(21) Appl. No.: 14/942,116

(22) Filed: Nov. 16, 2015

Related U.S. Application Data
(60) Provisional application No. 62/080,504, filed on Nov. 17, 2014.

(51) Int. Cl. G06Q 40/04

(52) U.S. Cl. CPC G06Q 40/04

(57) ABSTRACT

The present invention is directed to in one embodiment a method for creating a secondary market for the auction based sale and transfer of any and all non-publically traded, private placed and/or restricted, securities, debt instruments and other financial derivatives (Commonly referred to herein generally as “privately placed securities”).

### CROSS REFERENCE TO RELATED APPLICATION

The present application claims priority to U.S. Provisional Application 62/080,504 filed Nov. 17, 2014.

### BACKGROUND OF THE INVENTION

The present invention is directed to in one embodiment a method for creating a secondary market for the auction based sale and transfer of any and all non-publically traded, private placed and/or restricted, securities, debt instruments and other financial derivatives (Commonly referred to herein generally as “privately placed securities”).

### SUMMARY OF THE INVENTION

The secondary market for the auction based sale and transfer may also include individual and/or portfolios of performing and non-performing loans and other debt instruments; and/or other securitized assets; in the U.S. and worldwide. In other embodiments of the invention there is provided a method for facilitating the pre-negotiated sale and transfer of: (i) any and all non-publically traded, private placed and/or restricted, securities, debt instruments and other financial derivatives; (ii) individual and/or portfolios of performing and non-performing loans and other debt instruments; and/or (iii) other securitized assets; in the U.S. and worldwide; from a willing security owner to a willing buyer.

### BRIEF DESCRIPTION OF THE DRAWINGS

FIG. 1 is a diagram illustrating from the owner side a secondary market for the auction based sale and transfer of any and all privately placed securities;

FIG. 2 is another diagram illustrating from the owner side a secondary market for the auction based sale and transfer of any and all privately placed securities;

FIG. 3 is a diagram illustrating a fund option for a secondary market for the auction based sale and transfer of any and all privately placed securities;

FIG. 4 is a diagram illustrating an auction side of a secondary market for the auction based sale and transfer of any and all privately placed securities;

FIG. 5 is a diagram illustrating from the purchaser side of a secondary market for the auction based sale and transfer of any and all privately placed securities;

FIG. 6 is a diagram illustrating a negotiated side for a secondary market for the auction based sale and transfer of any and all privately placed securities; and

FIG. 7 continues the diagram illustration from FIG. 6.

### DETAILED DESCRIPTION OF THE DRAWINGS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention of the embodiments illustrated.

The figures provided are further examples of the invention embodiments and are outlined as follows:

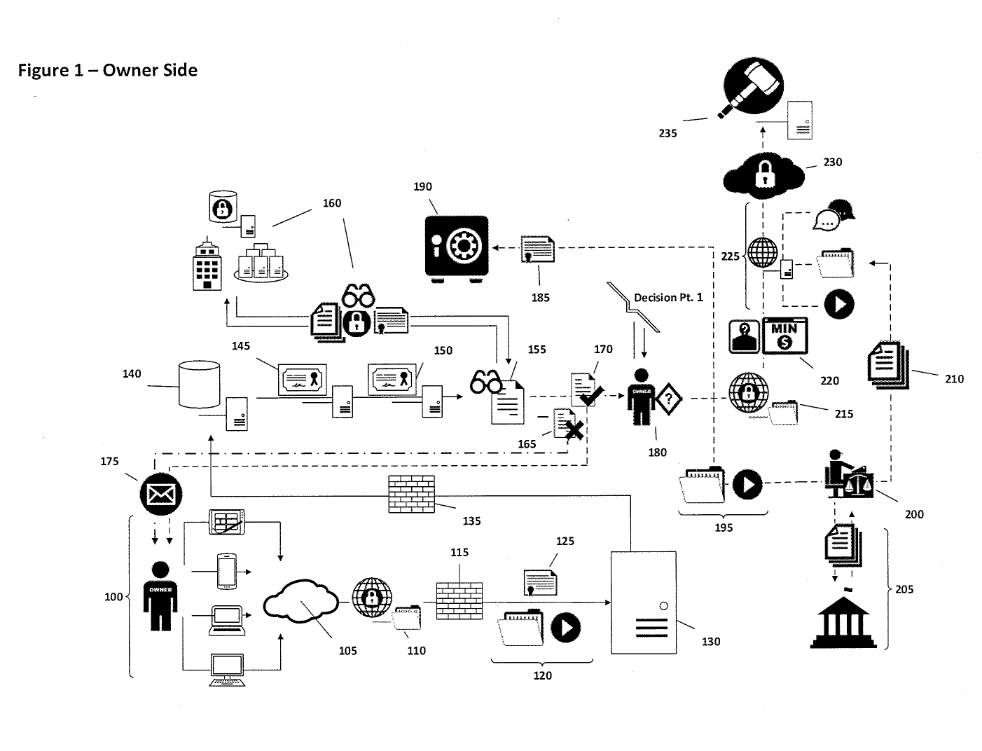

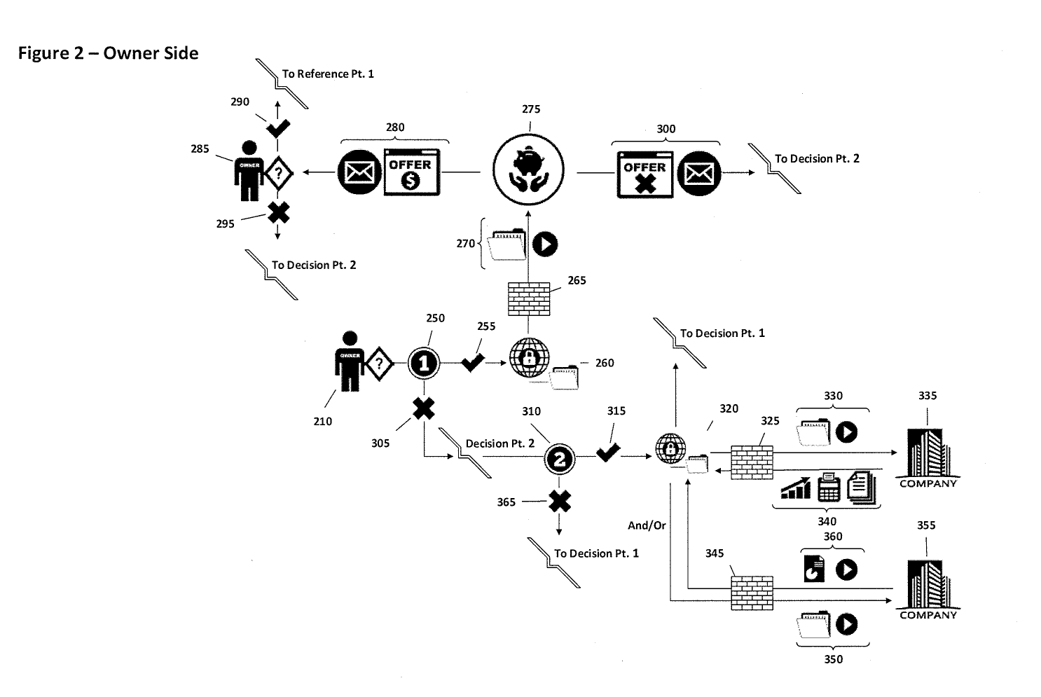

FIG. 1

| | |
|---|---|
| 100 | The owner of a particular security who wishes to place the security on the site for sale may access the |
| | platform via computer, laptop, smartphone, tablet and/or any other internet connected electronic |
| | device. |
| 105 | The security owner will initially access the portal via a cloud based, publically accessible, website. |
| 110 | From the publically accessible website in 105, the security owner will subsequently be directed to a |
| | secure area of the website where they will be prompted to provide detailed information regarding the |
| | subject security to be listed on the site. As part of this process the security owner will be required to |
| | upload (via a secure and encrypted, web based, document upload interface tool) any and all |
| | documentation evidencing the security and owner's acquisition of the security. Such documentation |
| | will include, without limitation: the name of issuer; contact information for issuer; date of acquisition; |
| | copies of any original purchase/acquisitions documents; associated private placement memoranda |
| | and the like; financial statements subsequently received by the owner related to the subject security; |
| | any related video, streaming media or similar materials related to the security and/or the issuing |
| | company; and a copy of the physical security (if any). |
| 115 | Protective firewall. |
| 120 | Represents the upload, by the security owner, of all agreements, documents, streaming media and the |
| | like related to the subject security being offered for sale. |
| 125 | Represents the upload, by the security owner, of a copy of the physical security (if any). |
| 130 | Primary portal server. The security information will pass through this server and be directed to a non- |
| | public initial database. |
| 135 | Protective firewall. |
| 140 | Non-public initial database for the initial storage of information related to the subject security. This |
| | information will be coded based on internal algorithms for purposes of screening. |
| 145 | Initial security screening database. This database will automatically pre-screen the coded security |
| | information based on applicable statutory holding period (if any) and other legal and contractual |
| | transfer restrictions. |
| 150 | Secondary security screening database. This database will further screen the coded security |
| | information based on verification of issuer and security information against internal offering record |
| | database and other predetermined internal anti-fraud criteria. |
| 155 | Employee screening and verification of prescreening results. |
| 160 | Employee verification/automated verification (as applicable) of owner provided security information |
| | with information provided by the issuing company, third party stock recording entities, and/or internal |
| | secured completed deal information database (495). |
| 165 | If the information provided by the owner fails to pass one or more of the screening/verification |
| | processes in steps 145, 150, 155 and/or 160, the system will automatically flag the subject security |
| | and the subject security will not be permitted to be sold through the portal. |
| 170 | If the information provided by the owner passes each of the screening/verification processes in steps |
| | 145, 150, 155 and/or 160, the owner will be permitted to move to the next step. |
| 175 | If the information provided by the owner fails to pass one or more of the screening/verification |
| | processes in steps 145, 150, 155 and/or 160, the owner will receive an automated email (and/or other |
| | electronic means of notification) of such decision together with the reason(s) for such failure and the |
| | process (if any) for curing such failure (e.g. the provision of additional required information, etc.). If |
| | the information provided by the owner passes each of the screening/verification processes in steps |
| | 145, 150, 155 and 160, the owner will receive an automated email (and/or other electronic means of |
| | notification) and will be directed to: (a) deliver the original security (if any) the Company for escrow; |
| | and (b) to continue with the registration of the subject security. |
| 180 | Security owner will be given the option to: (a) solicit an immediate offer from an investment fund |
| | affiliate of the Company qualified to hold the subject security; (b) obtain (at additional expense) |
| | consulting services of the Company and/or its affiliates in estimating the value range/acceptable |
| | pricing range of the subject security; and/or (c) obtain (at additional expense) consulting services of |
| | the Company and/or its affiliates in preparing marketing and related materials in connection with the |
| | auction of the subject security. See FIG. 2 for more detail regarding these options. |
| 185 | Represents the physical security, if any, delivered by the owner to the Company as directed in the |
| | email (and/or other electronic means of notification) described in step 175. |
| 190 | Secured physical escrow of the subject physical security, if any, pending the closing or termination of |
| | the subject sale (as applicable). |
| 195 | If the information provided by the owner passes each of the screening/verification processes in steps |
| | 145, 150, 155 and 160, the information will be passed along to the Company's internal/external legal |
| | department (as applicable). |
| 200 | The Company's internal/external legal department (as applicable). |
| 205 | The Company will prepare (with cooperation from the security owner, as required) all necessary pre- |
| | sale regulatory/compliance documentation and file the same with the appropriate governmental |
| | agency(ies). |
| 210 | Copies of all filed pre-sale regulatory/compliance documentation (if any) will be uploaded |
| | automatically, by the Company, to the “due diligence” documents included in the subject security |
| | auction materials. |
| 215 | If the information provided by the owner passes each of the screening/verification processes in steps |
| | 145, 150, 155 and 160, the owner will have access to upload (via a secure and encrypted, web based, |
| | document upload interface tool) any and all additional documentation/streaming media (or similar |
| | materials) regarding the security (including, without limitation, any information received in connection |
| | with the option in step 210(c). |
| 220 | Owner will establish a minimum reserve auction price above which the security must be sold to the |
| | winning bidder (if any) and a deadline for the expiration of the auction. At the election of the security |
| | owner, the name of the security owner will be kept confidential and all references to, and |
| | communications with, the security owner in the auction webpage will be made under an alias |
| | username chosen by the security owner. If this option is elected, only the Company, the purchasing |
| | person, the issuing company/third party stock recording entity and the applicable governmental |
| | agencies (if any) will be made aware of the actual identity of the security owner. Verification of the |
| | actual identity of the security owner will however be made by the Company prior to the auction being |
| | made public (and as a condition thereof). |
| 225 | All information regarding the security (including, without limitation, the copies of all filed pre-sale |
| | regulatory/compliance documentation, if any) will be uploaded to a restricted database (accessible via |
| | the secured cloud based platform identified in 230) and a webpage will be created specifically for the |
| | auction of the subject security and the viewing of the related security information/documentation. |
| | Once uploaded to the webpage, and the webpage is made active on the auction server (235), the |
| | owner will have limited access to limit/delete uploaded information without the consent of the |
| | Company. The webpage will also provide for a secure method of communication between the owner |
| | and potential bidders which will permit a bidder/potential bidder to ask questions related to the |
| | subject security, the issuing company and/or related matters (and to receive responses from the |
| | owner to such questions) and to view the questions asked by other bidders/potential bidders (and the |
| | responses provided by owner in response to such questions). |
| 230 | Represents the secure, cloud based, access to the offering webpage for the auction of the subject |
| | security. Only pre-vetted persons who are qualified to purchase/hold the subject securities (as |
| | determined in step 735) will be permitted access to the auction webpage. |
| 235 | The primary auction server. This will be a secure server which will handle the facilitation of the auction |
| | process (including the acceptance of bids and the determination of winning bids) for each security |
| | auction. |
| 240 | Reserved. |
| 245 | Reserved. |

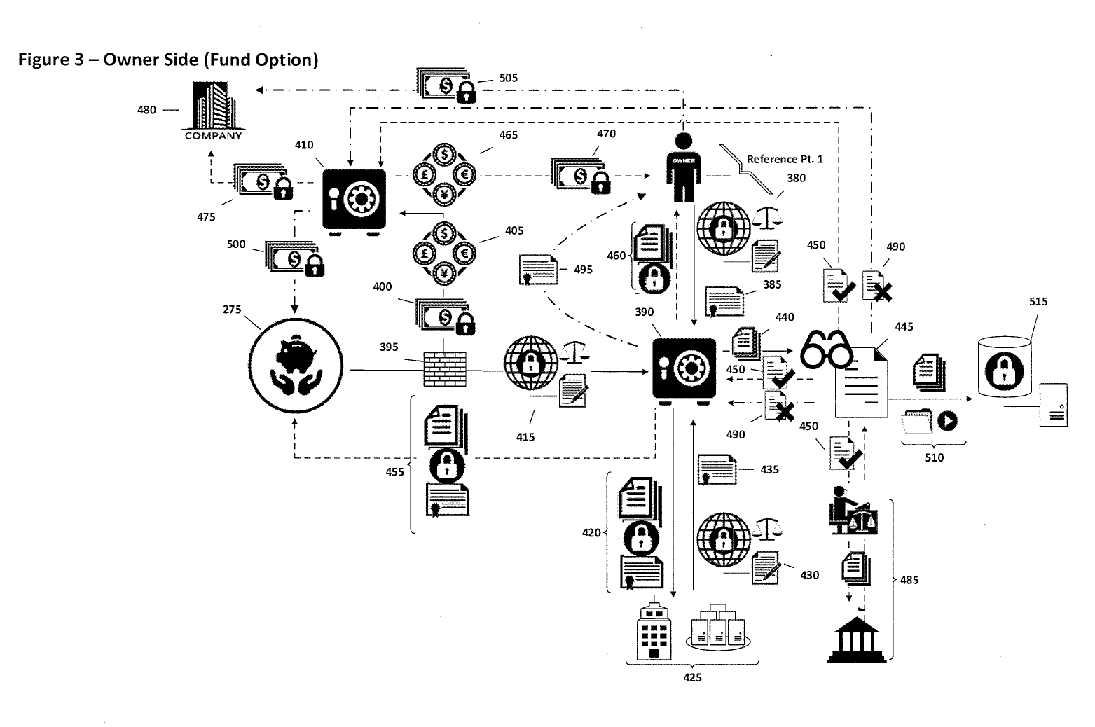

FIG. 2

| | |
|---|---|
| 250 | Security owner will first be given the option to solicit an immediate offer from an investment fund |
| | affiliate of the Company qualified to hold the subject security. |
| 255 | Security owner elects to solicit an immediate offer from an investment fund affiliate of the Company |
| | qualified to hold the subject security. |
| 260 | The owner will have access to upload (via a secure and encrypted, web based, document upload |
| | interface tool) any and all additional documentation/streaming media (or similar materials) regarding |
| | the security it wishes to share with the investment fund. |
| 265 | Protective firewall. |
| 270 | All of the information regarding the subject security (including, without limitation, any and all |
| | documentation, streaming media, and other materials) will be passed along to each investment fund |
| | affiliate of the Company qualified to hold the subject security (if any). |
| 275 | Represents investment fund affiliate(s) of the Company qualified to hold the subject security (if any). |
| 280 | One or more of the investment fund affiliates of the Company qualified to hold the subject security (if |
| | any) may elect to submit a one-time offer to the security owner to purchase the subject security |
| | outright. If one or more such offers are made the security owner will be notified via email (and/or |
| | other electronic means of notification). |
| 285 | Upon receipt of an offer email (and/or other electronic means of notification of offer) the security |
| | owner will have a fixed amount of time to accept or reject each offer (or it will automatically be |
| | deemed rejected if no response is made within the allotted response period). If one or more offers are |
| | submitted from qualified investment fund affiliates of the Company, the security owner may only |
| | accept one of the offers and, upon such acceptance, the remaining offers will be deemed rejected. |
| 290 | If an offer submitted from an investment fund affiliate of the Company is accepted by the security |
| | owner, the process to facilitate the transfer and sale of the subject security to the investment fund |
| | affiliate will begin (see FIG. 3, commencing with “Reference Pt. 1”). |
| 295 | If one or more offers are submitted from qualified investment fund affiliates of the Company, and |
| | either each offer is rejected by the security owner, or owner fails to accept an offer or otherwise |
| | respond to the offers within the allotted time, all open offers will then be automatically deemed |
| | rejected and the security owner will be directed to option 2 (see FIG. 2 “Decision Pt. 2”). |
| 300 | If there are no investment fund affiliates of the Company qualified to hold the subject security, or no |
| | investment fund affiliate of the Company elects to submit an offer to the security owner to purchase |
| | the subject security, the security owner will be notified via email (and/or other electronic means of |
| | notification) and will be directed to option 2 (see FIG. 2 “Decision Pt. 2.”). |
| 305 | If the security owner elects not to solicit an immediate offer from an investment fund affiliate of the |
| | Company, the security owner will be directed to option 2 (see FIG. 2 “Decision Pt. 2.”). |
| 310 | The owner will be given the option to obtain (at additional expense) consulting services of the |
| | Company and/or its affiliates in (a) estimating the value range/acceptable pricing range of the subject |
| | security; and/or (b) preparing marketing and related materials in connection with the auction of the |
| | subject security. |
| 315 | Represents the acceptance of security owner to obtain one or both of the additional consulting |
| | services described in 310. |
| 320 | If owner elects to obtain one or both of the additional consulting services described in 310, the owner |
| | will have access to upload (via a secure and encrypted, web based, document upload interface tool) |
| | any and all additional documentation/streaming media (or similar materials) regarding the security it |
| | wishes to share with the Company and/or its affiliates in connection with the provision of such |
| | ancillary services. |
| 325 | Protective firewall. |
| 330 | If owner elects to obtain the additional consulting services described in 310(a), all of the information |
| | regarding the subject security (including, without limitation, any and all documentation, streaming |
| | media, and other materials) will be passed along to the appropriate internal department of the |
| | Company and/or its affiliates in connection with the provision of such ancillary services. |
| 335 | Represents the applicable internal department of the Company and/or its affiliates in connection with |
| | the provision of the subject ancillary services. |
| 340 | If owner elects to obtain the additional consulting services described in 310(a), applicable internal |
| | department of the Company and/or its affiliates will prepare a market based appraisal of the subject |
| | security providing, without limitation, an estimate fair market value range of the subject security and |
| | an explanation of the calculation of value range. |
| 345 | Protective firewall. |
| 350 | If owner elects to obtain the additional consulting services described in 310(b), all of the information |
| | regarding the subject security (including, without limitation, any and all documentation, streaming |
| | media, and other materials) will be passed along to the appropriate internal department of the |
| | Company and/or its affiliates in connection with the provision of such ancillary services. |
| 355 | Represents the appropriate internal department of the Company and/or its affiliates in connection |
| | with the provision of the subject ancillary services. |
| 360 | If owner elects to obtain the additional consulting services described in 310(b), applicable internal |
| | department of the Company and/or its affiliates will prepare marketing and related materials in |
| | connection with the auction of the subject security. |
| 365 | Reserved. |
| 370 | Reserved. |
| 375 | Reserved. |

FIG. 3

| | |
|---|---|
| 380 | If an offer submitted from an investment fund affiliate of the Company is accepted by the security |
| | owner, the owner will be directed to a secure area of the website and instructed to complete all |
| | necessary documents in order to legally evidence and effectuate the transfer and sale of the subject |
| | security from the security owner to the purchasing investment fund affiliate of the Company. |
| | Document completion will be conducted through a secure and encrypted, web based, interface tool |
| | which will include, among other things, the ability to electronically sign the subject transfer |
| | documents (to the extent allowable under applicable law) and the encrypted electronic transfer of the |
| | final executed transfer documents to the secure document escrow database. To the extent any one or |
| | more of the transfer documents cannot be electronically signed by the security owner (as a result of |
| | applicable law or otherwise), the security owner will be instructed to (and how to) print and execute |
| | the applicable transfer documents and to deliver the executed physical documents to the Company to |
| | be held in escrow pending the closing or termination (as applicable) of the sale and transfer of the |
| | subject security by the security owner to the purchasing investment fund affiliate of the Company. |
| 385 | If the subject security is represented by a physical certificate, the security owner will be required to |
| | deliver the physical security (or an executed lost certificate affidavit (or the like) if the certificate |
| | cannot be located) to the Company to be held in secure escrow pending the closing or termination (as |
| | applicable) of the sale and transfer of the subject security to the purchasing investment fund affiliate |
| | of the Company. |
| 390 | Represents the secure escrow (and escrow database, to the extent any one or more of the documents |
| | were signed electronically) holding: (a) the final transfer documents executed by the security owner |
| | and the purchasing investment fund affiliate of the Company; (b) the original certificate (if any |
| | evidencing the subject security; and (c) the transfer documents executed/acknowledged by the issuing |
| | company and/or the applicable third party stock recording entity, and the replacement physical |
| | security (if any), received by the Company pursuant to 430 and 435. |
| 395 | Protective firewall. |
| 400 | If an offer submitted from an investment fund affiliate of the Company is accepted by the security |
| | owner, the purchasing an investment fund affiliate of the Company will be directed to deposit the full |
| | amount of funds into escrow with the Company. The funds will be held in a broker escrow account |
| | pending the closing or termination (as applicable) of the sale and transfer of the subject security to the |
| | purchasing investment fund affiliate of the Company. The transfer of funds will be conducted (except |
| | as described in 405) via a direct wire, ACH transfer or other secured transfer of funds from the |
| | purchasing investment fund affiliate of the Company to the applicable broker escrow account. |
| 405 | To the extent the purchasing investment fund affiliate of the Company will have to have any portion or |
| | all of its funds converted from one accepted form of currency to another accepted form of currency in |
| | order to for such funds to be deposited into the applicable escrow account (and/or as may otherwise |
| | be required by law), the purchasing investment fund affiliate of the Company will be directed to |
| | transfer the funds to an affiliate of the Company (or an unrelated third party selected by the |
| | Company) who will facilitate the conversion of such funds and will then deposit the converted funds |
| | directly into the applicable broker escrow account. |
| 410 | Standard broker escrow account used in connection with the purchase and sale of securities. All |
| | interest of the escrowed funds, if any, will be: (a) paid to the security owner if/when fie sale and |
| | transfer of the subject security is closed (see 465); (b) paid to the purchasing investment fund affiliate |
| | of the Company if/when the sale and transfer of the subject security is terminated (see 505). |
| 415 | If an offer submitted from an investment fund affiliate of the Company is accepted by the security |
| | owner, the purchasing investment fund affiliate of the Company will be directed to a secure area of |
| | the website and instructed to complete all necessary documents in order to legally evidence and |
| | effectuate the purchase and acceptance of the subject security from the security owner to the |
| | purchasing investment fund affiliate of the Company. Document completion will be conducted |
| | through a secure and encrypted, web based, interface tool which will include, among other things, the |
| | ability to electronically sign the subject transfer documents (to the extent allowable under applicable |
| | law) and the encrypted electronic transfer of the final executed transfer documents to the secure |
| | document escrow database. To the extent any one or more of the transfer documents cannot be |
| | electronically signed by the purchasing investment fund affiliate of the Company (as a result of |
| | applicable law or otherwise), the purchasing investment fund affiliate of the Company will be |
| | instructed to (and how to) print and execute the applicable transfer documents and to deliver the |
| | executed physical documents to the Company to be held in escrow pending the closing or termination |
| | (as applicable) of the sale and transfer of the subject security by the security owner to the purchasing |
| | investment fund affiliate of the Company. |
| 420 | Once all of the executed transfer documents (and the original certificate evidencing the subject |
| | security, if any) have been delivered by the security owner and the purchasing investment fund |
| | affiliate of the Company, the Company shall deliver copies of such documents (via a secure and |
| | encrypted, web based data/document transfer method) and/or original copies of such documents (to |
| | the extent required) to the applicable transfer agent of the issuing company/third party stock |
| | recording entity (as applicable). |
| 425 | Represents the issuing company/third party stock recording entity (as applicable). |
| 430 | The Company will oversee the execution/acknowledgment (as applicable) of all required transfer |
| | documents (if any), and the issuance and delivery of a replacement physical security (if any) in the |
| | name of the purchasing investment fund affiliate of the Company, by the issuing company and/or the |
| | applicable third party stock recording entity. |
| 435 | Represents the issuance and delivery of a replacement physical security (if any) in the name of the |
| | purchasing investment fund affiliate of the Company. |
| 440 | Once all of the executed transfer documents (and the original replacement certificate evidencing the |
| | subject security, if any) have been delivered by the security owner, the purchasing investment fund |
| | affiliate of the Company, and the issuing company and/or the applicable third party stock recording |
| | entity, copies of all documents will be delivered electronically to the document review department of |
| | the Company. |
| 445 | The applicable document review department of the Company. |
| 450 | If the document review department of the Company, after reviewing all received executed transfer |
| | documents, determines that all documents necessary to evidence the transfer of the subject security |
| | from the security owner to the purchasing investment fund affiliate of the Company have been |
| | properly executed and received by the Company, the head of the document review department of the |
| | Company will authorize the simultaneous distribution of: (a) copies of all executed transfer |
| | documentation (including, without limitation, all transfer documentation evidencing the ownership of |
| | the subject security in the name of the purchasing investment fund affiliate of the Company), and the |
| | replacement security (if any), from the document escrow to the purchasing investment fund affiliate |
| | of the Company (455); (b) copies of all executed transfer documentation from the document escrow |
| | to the security owner (460); (c) the distribution of the escrowed funds (less the Company's transaction |
| | and other fees payable by the security owner) from the broker escrow account to the security owner |
| | (470); and (d) an amount equal to the Company's transaction and other fees payable by the security |
| | owner from the broker escrow account to the accounts payable department of the Company (475). |
| | The head of the document review department of the Company will also authorize an direct the |
| | Company's internal legal department (and/or outside counsel) to complete and file all necessary |
| | notice, compliance and related documents (if any) with the applicable governmental agency (485) and |
| | deliver filed copies (to the extent received) of such documents to the security owner and the |
| | purchasing investment fund affiliate of the Company, All document transfers from escrow will be done |
| | via encrypted electronic transfer to the extent possible subject to applicable law or otherwise, |
| 455 | Distribution of copies of all executed transfer documentation (including, without limitation, all transfer |
| | documentation evidencing the ownership of the subject security in the name of the purchasing |
| | investment fund affiliate of the Company, and copies of any and all notice, compliance and related |
| | documents filed and received by the Company), and the replacement security (if any), from the |
| | document escrow to the purchasing investment fund affiliate of the Company. |
| 460 | Distribution of copies of all executed transfer documentation (including, without limitation, copies of |
| | any and all notice, compliance and related documents filed and received by the Company) from the |
| | document escrow to the security owner. |
| 465 | To the extent the security owner has elected to receive the escrowed funds in an accepted form of |
| | currency other than the form of the escrowed funds, the escrow agent will be directed by the |
| | Company to transfer the escrowed funds to an affiliate of the Company (or an unrelated third party |
| | selected by the Company) who will facilitate the conversion of such funds and will then deposit the |
| | converted funds directly into the applicable deposit account selected by the security owner. |
| 470 | Distribution of the escrowed funds from the broker escrow account to the security owner via a direct |
| | wire, ACH transfer or other secured transfer of funds from the broker escrow account to the deposit |
| | account selected by the security owner. |
| 475 | Distribution of an amount equal to the Company's transaction and other fees payable by the security |
| | owner from the broker escrow account to the accounts payable department of the Company via a |
| | direct wire, ACH transfer or other secured transfer of funds from the broker escrow account to the |
| | deposit account selected by the accounts payable department of the Company. |
| 480 | Accounts payable department of the Company. |
| 485 | The Company's internal legal department (and/or outside counsel) will complete and file all necessary |
| | notice, compliance and related documents (if any) with the applicable governmental agency and |
| | deliver filed copies (to the extent received) of such documents to the security owner and the |
| | purchasing investment fund affiliate of the Company. |
| 490 | If the document review department of the Company, after reviewing all received executed transfer |
| | documents, determines that all documents necessary to evidence the transfer of the subject security |
| | from the security owner to the purchasing investment fund affiliate of the Company have not (for |
| | whatever reason) been properly executed and received by the Company, and/or for whatever reason |
| | the transfer of the subject securities cannot be completed (including without limitation, as the result |
| | of any legal action) the head of the document review department of the Company will authorize the |
| | simultaneous distribution of: (a) the original physical security (if any), from the document escrow to |
| | the security owner (495); and (b) the distribution (return) of the escrowed funds from the broker |
| | escrow account to the purchasing investment fund affiliate of the Company (500). |
| 495 | The original physical security (if any). |
| 500 | Distribution (return) of the escrowed funds from the broker escrow account to the purchasing |
| | investment fund affiliate of the Company via a direct wire, ACH transfer or other secured transfer of |
| | funds from the broker escrow account to the deposit account selected by the purchasing investment |
| | fund affiliate of the Company. |
| 505 | If the document review department of the Company, after reviewing all received executed transfer |
| | documents, determines that all documents necessary to evidence the transfer of the subject security |
| | from the security owner to the purchasing investment fund affiliate of the Company have not (for |
| | whatever reason) been properly executed and received by the Company, and/or for whatever reason |
| | the transfer of the subject securities cannot be completed (including without limitation, as the result |
| | of any legal action) the head of the document review department of the Company will cause the |
| | security owner to be notified and the security owner will be required to pay to the accounts payable |
| | department of the Company an amount equal to the minimum/termination fee established by the |
| | Company (if any). Such payment to be made via a direct wire, ACH transfer or other secured transfer |
| | of funds from the broker escrow account to the deposit account selected by the accounts payable |
| | department of the Company. |
| 510 | Copies of any and all information submitted by (or on behalf of) the security owner and purchasing |
| | investment fund affiliate of the Company, and copies of any and all transfer and other documentation |
| | pertaining to the purchase and sale of the subject security will be coded and stored electronically on |
| | an internal, secured, non-public database (515). Such information will be collected whether or not the |
| | subject sale has closed. |
| 515 | Internal, secured, non-public database specifically for the recording and storing of all |
| | completed/terminated deal documents and other information received by the Company in connection |
| | therewith, including without limitation, the names of the security owner, the purchasing investment |
| | fund affiliate of the Company, the issuing company/third party stock recording entity (as applicable; |
| | and the applicable contact(s) at such issuing company/third party stock recording entity), the |
| | applicable governmental agencies contacted in connection with the transaction (if any; and the |
| | applicable contact(s) at such governmental agency); and all correspondence between the parties (or |
| | any of them) and the Company. |
| 520 | Reserved. |
| 525 | Reserved. |
| 530 | Reserved. |
| 535 | Reserved. |

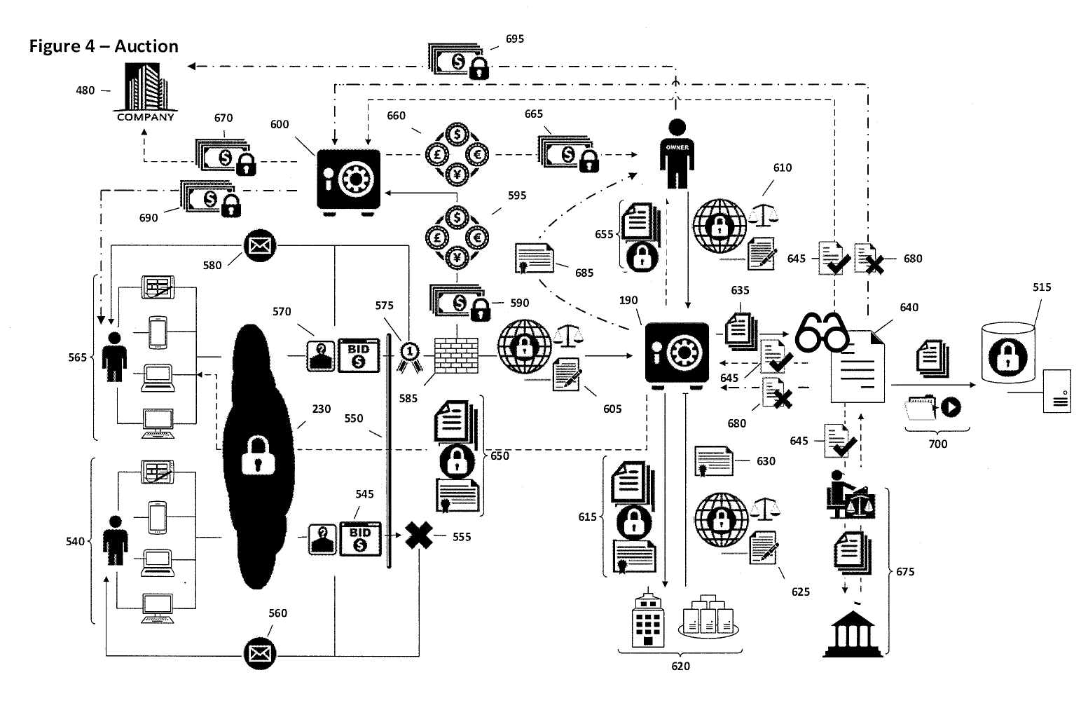

FIG. 4

| | |
|---|---|
| 540 | A potential purchaser may access the platform via computer, laptop, smartphone, tablet and/or any |
| | other internet connected electronic device. A potential purchaser will be able to see and sort certain |
| | basic general identifying information regarding the security auctions then currently available on the |
| | platform via the cloud based, publically accessible, website (720) but will only be granted access to |
| | certain actual auction webpages (230) based on their internally designated “investor” certification |
| | status (as determined in step 735) as a person who is qualified to purchase/hold the subject security. |
| 545 | If granted access to a particular auction webpage, the potential purchaser may place as many bids as |
| | they wish during the allotted auction time, At the election of the prospective purchaser, the name of |
| | the prospective purchaser will be kept confidential and all references to, and communications with, |
| | the prospective purchaser in the auction webpage will be made under an alias username chosen by |
| | the prospective purchaser. If this option is elected, only the Company and (if such prospective |
| | purchaser is the winning bidder) the security owner, the issuing company/third party stock recording |
| | entity and the applicable governmental agencies (if any) will be made aware of the actual identity of |
| | the purchaser. Verification of the actual identity of the prospective purchaser will however be made |
| | by the Company prior to the effectiveness of the first bid made by such prospective purchaser (and as |
| | a condition thereof). |
| 550 | Auction deadline established by security owner in step 220. |
| 555 | After the auction deadline the system will automatically determine the winning bid. This represents a |
| | non-winning bid. |
| 560 | The potential purchaser will be notified by email (and or other electronic means of notification): (a) |
| | once a bid is placed (and each time a bid is placed) to confirm the amount of the bid and related |
| | terms; and (b) after the expiration of the auction, as to whether the potential purchaser had the |
| | winning bid or did not have the winning bid |
| 565 | If granted access to a particular auction webpage, the potential purchaser may place as many bids as |
| | they wish during the allotted auction time. At the election of the prospective purchaser, the name of |
| | the prospective purchaser will be kept confidential and all references to, and communications with, |
| | the prospective purchaser in the auction webpage will be made under an gas username chosen by |
| | the prospective purchaser. If this option is elected, only the Company and (if such prospective |
| | purchaser is the winning bidder) the security owner, the issuing company/third party stock recording |
| | entity and the applicable governmental agencies (if any) will be made aware of the actual identity of |
| | the purchaser. Verification of the actual identity of the prospective purchaser will however be made |
| | by the Company prior to the effectiveness of the first bid made by such prospective purchaser (and as |
| | a condition thereof). |
| 570 | If granted access to a particular auction webpage, the potential purchaser may place as many bids as |
| | they wish during the allotted auction time. At the election of the prospective purchaser, the name of |
| | the prospective purchaser will be kept confidential and all references to, and communications with, |
| | the prospective purchaser in the auction webpage will be made under an alias username chosen by |
| | the prospective purchaser. If this option is elected, only the Company and (if such prospective |
| | purchaser is the winning bidder) the security owner, the issuing company/third party stock recording |
| | entity and the applicable governmental agencies (if any) will be made aware of the actual identity of |
| | the purchaser. Verification of the actual identity of the prospective purchaser will however be made |
| | by the Company prior to the effectiveness of the first bid made by such prospective purchaser (and as |
| | a condition thereof). |
| 575 | After the auction deadline the system will automatically determine the winning bid. This represents a |
| | winning bid. |
| 580 | The potential purchaser will be notified by email (and/or other electronic means of notification): (a) |
| | once a bid is placed (and each time a bid is placed) to confirm the amount of the bid and related |
| | terms; and (b) after the expiration of the auction deadline, as to whether the potential purchaser had |
| | the winning bid or did not have the winning bid. |
| 585 | Protective firewall, |
| 590 | If an offer submitted from a prospective purchaser is the winning bid after the expiration of the |
| | auction deadline, the winning purchaser will be directed to deposit the full amount of funds into |
| | escrow with the Company. The funds will be held in a broker escrow account pending the closing or |
| | termination (as applicable) of the sale and transfer of the subject security to the winning purchaser. |
| | The transfer of funds will be conducted (except as described in 595) via a direct wire, ACH transfer or |
| | other secured transfer of funds from the winning purchaser to the applicable broker escrow account. |
| 595 | To the extent the winning purchaser will have to have any portion or all of its funds converted from |
| | one accepted form of currency to another accepted form of currency in order to for such funds to be |
| | deposited into the applicable escrow account (and/or as may otherwise be required by law), the |
| | winning purchaser will be directed to transfer the funds to an affiliate of the Company (or an |
| | unrelated third party selected by the Company) who will facilitate the conversion of such funds and |
| | will then deposit the converted funds directly into the applicable broker escrow account. |
| 600 | Standard broker escrow account used in connection with the purchase and sale of securities. All |
| | interest of the escrowed funds, if any, will be: (a) paid to the security owner if/when the sale and |
| | transfer of the subject security is closed (see 660); (b) paid to the winning purchaser if/when the sale |
| | and transfer of the subject security is terminated (see 685). |
| 605 | If an offer submitted from a prospective purchaser is the winning bid after the expiration of the |
| | auction deadline, the winning purchaser will be directed to a secure area of the website and instructed |
| | to complete all necessary documents in order to legally evidence and effectuate the purchase and |
| | acceptance of the subject security from the security owner to the winning purchaser. Document |
| | completion will be conducted through a secure and encrypted, web based, interface tool which will |
| | include, among other things, the ability to electronically sign the subject transfer documents (to the |
| | extent allowable under applicable law) and the encrypted electronic transfer of the final executed |
| | transfer documents to the secure document escrow database. To the extent any one or more of the |
| | transfer documents cannot be electronically signed by the winning purchaser (as a result of applicable |
| | law or otherwise), the winning purchaser will be instructed to (and how to) print and execute the |
| | applicable transfer documents and to deliver the executed physical documents to the Company to be |
| | held in escrow pending the closing or termination (as applicable) of the sale and transfer of the subject |
| | security by the security owner to the winning purchaser. |
| 610 | If an offer submitted from a prospective purchaser is the winning bid after the expiration of the |
| | auction deadline, the owner will be directed to a secure area of the website and instructed to |
| | complete all necessary documents in order to legally evidence and effectuate the transfer and sale of |
| | the subject security from the security owner to the winning purchaser. Document completion will be |
| | conducted through a secure and encrypted, web based, interface tool which will include, among other |
| | things, the ability to electronically sign the subject transfer documents (to the extent allowable under |
| | applicable law) and the encrypted electronic transfer of the final executed transfer documents to the |
| | secure document escrow database, To the extent any one or more of the transfer documents cannot |
| | be electronically signed by the security owner (as a result of applicable law or otherwise), the security |
| | owner will be instructed to (and how to) print and execute the applicable transfer documents and to |
| | deliver the executed physical documents to the Company to be held in escrow pending the closing or |
| | termination (as applicable) of the sale and transfer of the subject security by the security owner to the |
| | winning purchaser. |
| 615 | Once all of the executed transfer documents (and the original certificate evidencing the subject |
| | security, if any) have been delivered by the security owner and the purchasing investment fund |
| | affiliate of the Company, the Company shall deliver copies of such documents (via a secure and |
| | encrypted, web based data/document transfer method) and/or original copies of such documents (to |
| | the extent required) to the applicable transfer agent of the issuing company/third party stock |
| | recording entity (as applicable). |
| 620 | Represents the issuing company/third party stock recording entity (as applicable). |
| 625 | The Company will oversee the execution/acknowledgment (as applicable) of all required transfer |
| | documents (if any), and the issuance and delivery of a replacement physical security (if any) in the |
| | name of the winning purchaser, by the issuing company and/or the applicable third party stock |
| | recording entity. |
| 630 | Represents the issuance and delivery of a replacement physical security (if any) in the name of the |
| | winning purchaser. |
| 635 | Once all of the executed transfer documents (and the original replacement certificate evidencing the |
| | subject security, if any) have been delivered by the security owner, the winning purchaser, and the |
| | issuing company and/or the applicable third party stock recording entity, copies of all documents will |
| | be delivered electronically to the document review department of the Company. |
| 640 | The applicable document review department of the Company. |
| 645 | If the document review department of the Company, after reviewing all received executed transfer |
| | documents, determines that all documents necessary to evidence the transfer of the subject security |
| | from the security owner to the winning purchaser have been properly executed and received by the |
| | Company, the head of the document review department of the Company will authorize the |
| | simultaneous distribution of: (a) copies of all executed transfer documentation (including, without |
| | limitation, all transfer documentation evidencing the ownership of the subject security in the name of |
| | the winning purchaser), and the replacement security (if any), from the document escrow to the |
| | winning purchaser (645); (b) copies of all executed transfer documentation from the document escrow |
| | to the security owner (650); (c) the distribution of the escrowed funds (less the Company's transaction |
| | and other fees payable by the security owner) from the broker escrow account to the security owner |
| | (660); and (d) an amount equal to the Company's transaction and other fees payable by the security |
| | owner from the broker escrow account to the accounts payable department of the Company (665), |
| | The head of the document review department of the Company will also authorize an direct the |
| | Company's internal legal department (and/or outside counsel) to complete and file all necessary |
| | notice, compliance and related documents (if any) with the applicable governmental agency (670) and |
| | deliver filed copies (to the extent received) of such documents to the security owner and the winning |
| | purchaser. All document transfers from escrow will be done via encrypted electronic transfer to the |
| | extent possible subject to applicable law or otherwise. |
| 650 | Distribution of copies of all executed transfer documentation (including, without limitation, all transfer |
| | documentation evidencing the ownership of the subject security in the name of the winning |
| | purchaser; and copies of any and all notice, compliance and related documents filed and received by |
| | the Company), and the replacement security (if any), from the document escrow to the winning |
| | purchaser. |
| 655 | Distribution of copies of all executed transfer documentation (including, without limitation, copies of |
| | any and all notice, compliance and related documents filed and received by the Company) from the |
| | document escrow to the security owner. |
| 660 | To the extent the security owner has elected to receive the escrowed funds in an accepted form of |
| | currency other than the form of the escrowed funds, the escrow agent will be directed by the |
| | Company to transfer the escrowed funds to an affiliate of the Company (or an unrelated third party |
| | selected by the Company) who will facilitate the conversion of such funds and will then deposit the |
| | converted funds directly into the applicable deposit account selected by the security owner. |
| 665 | Distribution of the escrowed funds from the broker escrow account to the security owner via a direct |
| | wire, ACH transfer or other secured transfer of funds from the broker escrow account to the deposit |
| | account selected by the security owner. |
| 670 | Distribution of an amount equal to the Company's transaction and other fees payable by the security |
| | owner from the broker escrow account to the accounts payable department of the Company via a |
| | direct wire, ACH transfer or other secured transfer of funds from the broker escrow account to the |
| | deposit account selected by the accounts payable department of the Company. |
| 675 | The Company's internal legal department (and/or outside counsel) will complete and file all necessary |
| | notice, compliance and related documents (if any) with the applicable governmental agency and |
| | deliver filed copies (to the extent received) of such documents to the security owner and the winning |
| | purchaser. |
| 680 | If the document review department of the Company, after reviewing all received executed transfer |
| | documents, determines that all documents necessary to evidence the transfer of the subject security |
| | from the security owner to the winning purchaser have not (for whatever reason) been properly |
| | executed and received by the Company, and/or for whatever reason the transfer of the subject |
| | securities cannot be completed (including without limitation, as the result of any legal action) the head |
| | of the document review department of the Company will authorize the simultaneous distribution of: |
| | (a) the original physical security (if any), from the document escrow to the security owner (685); and |
| | (b) the distribution (return) of the escrowed funds from the broker escrow account to the winning |
| | purchaser (695). |
| 685 | The original physical security (if any). |
| 690 | Distribution (return) of the escrowed funds from the broker escrow account to the winning purchaser |
| | via a direct wire, ACH transfer or other secured transfer of funds from the broker escrow account to |
| | the deposit account selected by the winning purchaser. |
| 695 | If the document review department of the Company, after reviewing all received executed transfer |
| | documents, determines that all documents necessary to evidence the transfer of the subject security |
| | from the security owner to the winning purchaser have not (for whatever reason) been properly |
| | executed and received by the Company, and/or for whatever reason the transfer of the subject |
| | securities cannot be completed (including without limitation, as the result of any legal action) the head |
| | of the document review department of the Company will cause the security owner to be notified and |
| | the security owner will be required to pay to the accounts payable department of the Company an |
| | amount equal to the minimum/termination fee established by the Company (if any). Such payment to |
| | be made via a direct wire, ACH transfer or other secured transfer of funds from the broker escrow |
| | account to the deposit account selected by the accounts payable department of the Company. |
| 700 | Copies of any and all information submitted by (or on behalf of) the security owner and winning |
| | purchaser, and copies of any and all transfer and other documentation pertaining to the purchase and |
| | sale of the subject security will be coded and stored electronically on an internal, secured, non-public |
| | database (515). Such information will be collected whether or not the subject sale has closed. |
| 705 | Reserved. |
| 710 | Reserved. |

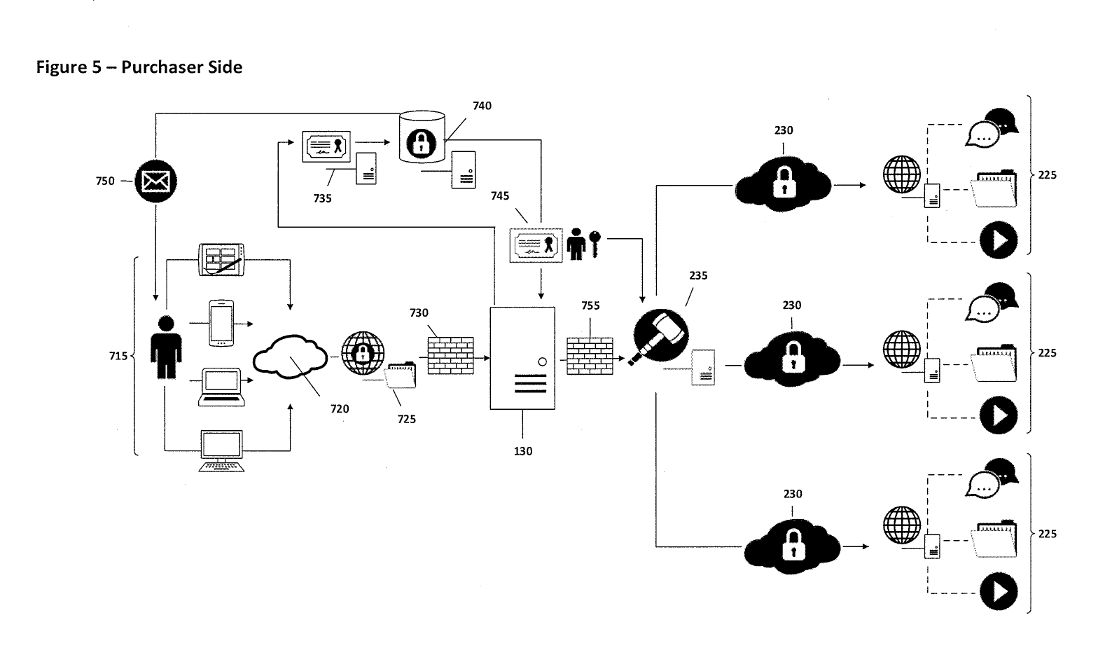

FIG. 5

| | |
|---|---|
| 715 | A potential purchaser may access the platform via computer, laptop, smartphone, tablet and/or any |
| | other internet connected electronic device. |
| 720 | The cloud based, publically accessible, website. A potential purchaser will be able to view and sort |
| | certain basic general identifying information regarding the security auctions then currently available |
| | on the platform via this cloud based, publically accessible, website but will only be granted access to |
| | certain actual auction webpages (230) based on prospective purchaser's internally designated |
| | “investor” certification (745) as a person who is qualified to purchase/hold the subject security. |
| 725 | From the publically accessible website in 720, the prospective purchaser will subsequently be directed |
| | to a secure area of the website where they will be prompted to provide detailed information regarding |
| | (among other things) their respective: investor qualification/sophistication and their ability to hold |
| | various types of investments. These qualifications will include, without limitation, certifications as to |
| | level of annual income, net worth, residency (state, country and city), education, prior investment |
| | activity. As part of this process the prospective purchaser will be required to upload (via a secure and |
| | encrypted, web based, document upload interface tool) any and all documentation evidencing such |
| | certifications made by such prospective purchaser. Such documentation will include, without |
| | limitation: a copy of such purchaser's valid driver's license, pay stub(s), filed tax return(s), financial |
| | statements, accountant/attorney certifications, and the like. All information received will be: (a) |
| | uploaded to the primary portal server (130); and (b) coded based on internal algorithms for purposes |
| | of screening. A prospective purchaser will have the opportunity to edit/update such information as |
| | necessary (subject to further restriction by the Company). |
| 730 | Protective firewall. |
| 735 | The certifications and supporting documents will pass through the primary portal server (130) and be |
| | directed to a non-public investor certification database. This database will automatically pre-screen |
| | the coded security information based on applicable legal and contractual transfer restrictions and |
| | other predetermined internal anti-fraud/classification criteria. The potential purchaser will then be |
| | automatically assigned an internal “investor” certification designation (745) which will determine |
| | which, if any, of the secure auction webpages (230) such prospective purchaser will be permitted to |
| | have access to. |
| 740 | The internal “investor” certification designation of each prospective purchaser, together with an and |
| | all information/documents received by such prospective purchaser in 725, will be coded and stored |
| | electronically on an internal, secured, non-public database. |
| 745 | Represents internal “investor” certification designation. |
| 750 | Once a prospective purchaser has been designated an internal “investor” certification: (a) the |
| | prospective purchaser will receive an automated email (and/or other electronic means of notification) |
| | that they are now permitted to access the primary auction website (located on the primary auction |
| | server; 235); and (b) the internal “investor” certification designation of each prospective purchaser will |
| | be stored in both the primary portal server (130) and the primary auction server (235) for purposes of |
| | allowing the prospective purchaser access to the primary auction website. On the primary auction |
| | website the prospective purchaser will be able to view and sort certain general/detailed information |
| | regarding the security auctions then currently available on the platform, and/or search for particular |
| | types of securities, but will only be granted access to such actual auction webpages (230) as are |
| | permitted based on such prospective purchaser's internally designated “investor” certification (745) as |
| | a person who is qualified to purchase/hold the subject security. |
| | Once a prospective purchaser has been designated an internal “investor” certification, such |
| | prospective purchaser will also have the option to elect to receive automatic alerts as new securities |
| | are added to the primary auction server: (a) based on the pre-established criteria (if any) selected by |
| | the prospective purchaser; and (b) such prospective purchaser's internally designated “investor” |
| | certification. If such option is elected, the prospective purchaser will receive an automated email |
| | (and/or other electronic means of notification) each time a new security (which satisfies the foregoing |
| | requirements (a) & (b)) is listed on the primary auction server. |
| 755 | Protective firewall. |
| 760 | Reserved. |
| 765 | Reserved. |
| 770 | Reserved. |

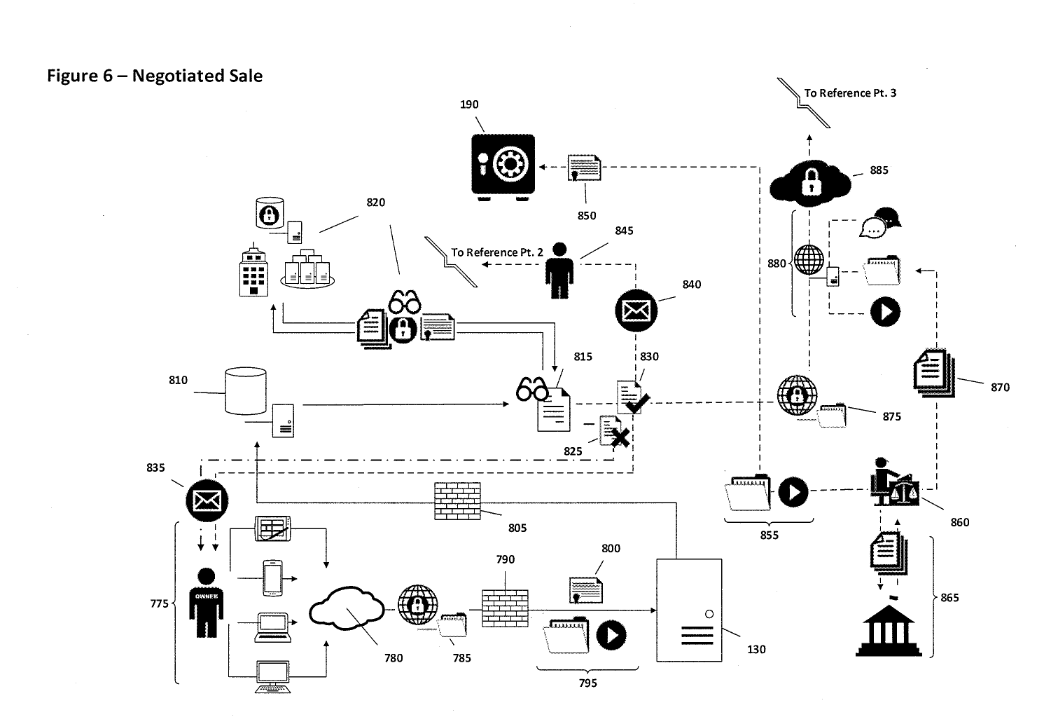

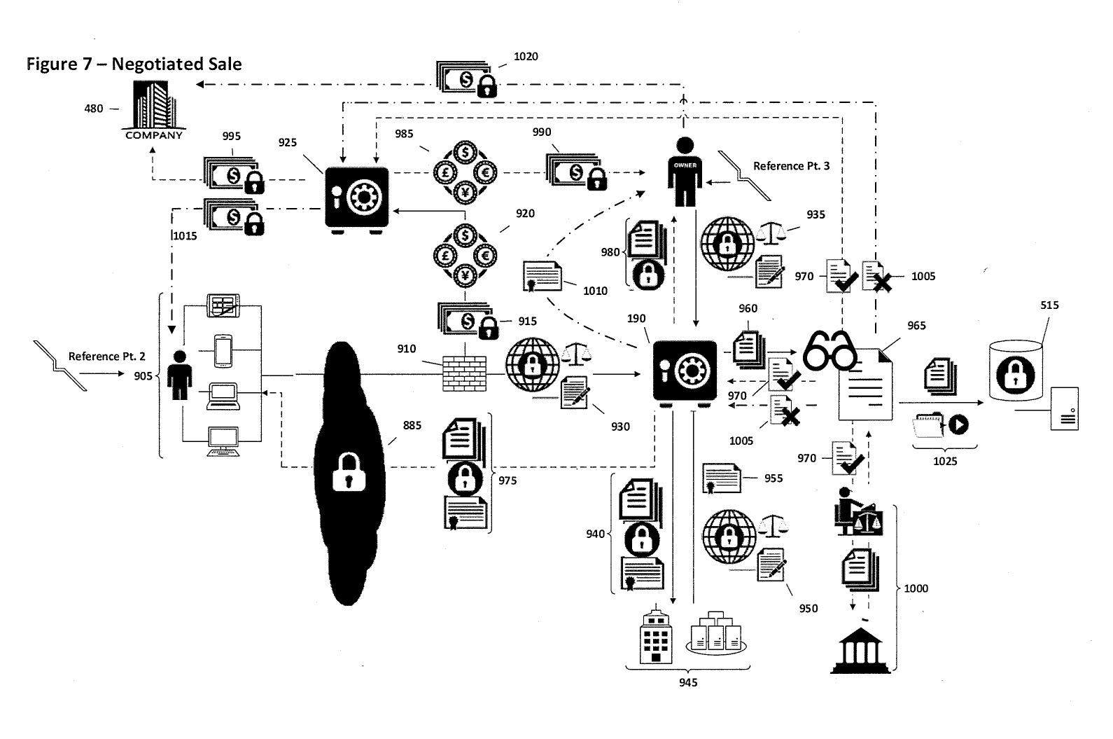

FIG. 6

| | |
|---|---|
| 775 | The owner of a particular security who wishes to utilize the site to facilitate a pre-negotiated sale of |
| | their security may access the platform via computer, laptop, smartphone, tablet and/or any other |
| | internet connected electronic device. |
| 780 | The security owner will initially access the portal via a cloud based, publically accessible, website. |
| 785 | From the publically accessible website in 105, the security owner will subsequently be directed to a |
| | secure area of the website where they will be prompted to provide detailed information regarding the |
| | subject security to be listed on the site. As part of this process the security owner will be required to |
| | upload (via a secure and encrypted, web based, document upload interface tool) any and all |
| | documentation evidencing the security and owner's acquisition of the security. Such documentation |
| | will include, without limitation: the name of issuer; contact information for issuer; date of acquisition; |
| | copies of any original purchase/acquisitions documents; associated private placement memoranda |
| | and the like; financial statements subsequently received by the owner related to the subject security; |
| | any related video, streaming media or similar materials related to the security and/or the issuing |
| | company; and a copy of the physical security (if any). Such materials will include, without limitation, |
| | the identify of the pre-negotiated purchaser, contact information for the pre-negotiated purchaser |
| | and copies of any and all materials provided by (or on behalf of) the security owner to the pre- |
| | negotiated purchaser. |
| 790 | Protective firewall. |
| 795 | Represents the upload, by the security owner, of all agreements, documents, streaming media and the |
| | like related to the subject security being offered for sale. The security information will be initially |
| | uploaded to the primary portal server (130) then passed through to a non-public initial database (810). |
| 800 | Represents the upload, by the security owner, of a copy of the physical security (if any). |
| 805 | Protective firewall. |
| 810 | Non-public initial database for the initial storage of information related to the subject security. This |
| | information will be coded based on internal algorithms for purposes of screening. |
| 815 | Employee screening and verification of uploaded materials. |
| 820 | Employee verification/automated verification (as applicable) of owner provided security information |
| | with information provided by the issuing company, third party stock recording entities, and/or internal |
| | secured completed deal information database (495). |
| 825 | If the information provided by the owner fails to pass one or more of the screening/verification |
| | processes in steps 815 and 820, the system will automatically flag the subject security and the subject |
| | security will not be permitted to be sold through the portal. |
| 830 | If the information provided by the owner passes each of the screening/verification processes in steps |
| | 815 and 820, the owner will be permitted to move to the next step. |
| 835 | If the information provided by the owner fails to pass one or more of the screening/verification |
| | processes in steps 815 and 820, the owner will receive an automated email (and/or other electronic |
| | means of notification) of such decision together with the reason(s) for such failure and the process (if |
| | any) for curing such failure (e.g. the provision of additional required information, etc.). If the |
| | information provided by the owner passes each of the screening/verification processes in steps 815 |
| | and 820, the owner will receive an automated email (and/or other electronic means of notification) |
| | and will be directed to: (a) deliver the original security (if any) the Company for escrow; and (b) to |
| | continue with the transfer and sale of the subject security. |
| 840 | If the information provided by the owner passes each of the screening/verification processes in steps |
| | 815 and 820, the pre-negotiated purchaser will receive an automated email (and/or other electronic |
| | means of notification) and will be directed to a secure link which will allow the pre-negotiated |
| | purchaser to: (a) first, log onto the site to, among other things, verify the information regarding the |
| | pre-negotiated purchaser provided by the security owner, and establish an account and password; and |
| | (b) to continue with the transfer and sale of the subject security (see FIG. 7, commencing with |
| | “Reference Pt. 2”). |
| 845 | Represents the pre-negotiated purchaser. |
| 850 | Represents the physical security, if any, delivered by the owner to the Company as directed in the |
| | email (and/or other electronic means of notification) described in step 835. |
| 855 | If the information provided by the owner passes each of the screening/verification processes in steps |
| | 815 and 820, the information will be passed along to the Company's internal/external legal |
| | department (as applicable). |
| 860 | The Company's internal/external legal department (as applicable). |
| 865 | The Company will prepare (with cooperation from the security owner, as required) all necessary pre- |
| | sale regulatory/compliance documentation and file the same with the appropriate governmental |
| | agency(ies). |
| 870 | Copies of all filed pre-sale regulatory/compliance documentation (if any) will be uploaded |
| | automatically, by the Company, to the “due diligence” documents included in the subject security sale |
| | materials. |
| 875 | If the information provided by the owner passes each of the screening/verification processes in steps |
| | 815 and 820, the owner will have access to upload (via a secure and encrypted, web based, document |
| | upload interface tool) any and all additional documentation/streaming media (or similar materials) |
| | regarding the security. |
| 880 | All information regarding the security (including, without limitation, the copies of all filed pre-sale |
| | regulatory/compliance documentation, if any) will be uploaded to a restricted database (accessible via |
| | the secured, non-public, cloud based platform identified in 885) and a webpage will be created |
| | specifically for the pre-negotiated transfer and sale of the subject security and the viewing of the |
| | related security information/documentation. Once uploaded to the webpage, the owner will have |
| | limited access to limit/delete uploaded information without the consent of the Company. The |
| | webpage will also provide for a secure method of communication between the owner and the pre- |
| | negotiated purchaser which will permit the pre-negotiated purchaser to ask questions related to the |
| | subject security, the issuing company and/or related matters (and to receive responses from the |
| | owner to such questions). |
| 885 | Represents the secure, cloud based, access to the webpage for the pre-negotiated transfer and sale of |
| | the subject security. Only the pre-negotiated purchaser, the security owner and the Company will be |
| | permitted access to the transfer and sale webpage, and the transfer and sale webpage will not be |
| | publically viewable or be identified on the website. |
| 890 | Reserved. |
| 895 | Reserved. |
| 900 | Reserved. |

FIG. 7

| | |
|---|---|
| 905 | Once the pre-negotiated purchaser receives the notification identified in step 840, they will be able to |
| | access the platform via computer, laptop, smartphone, tablet and/or any other internet connected |
| | electronic device. |
| 910 | Protective firewall. |
| 915 | The pre-negotiated purchaser will be directed to deposit the full amount of funds into escrow with the |
| | Company. The funds will be held in a broker escrow account pending the closing or termination (as |
| | applicable) of the sale and transfer of the subject security to the pre-negotiated purchaser. The |
| | transfer of funds will be conducted (except as described in 920) via a direct wire, ACH transfer or other |
| | secured transfer of funds from the pre-negotiated purchaser to the applicable broker escrow account. |
| 920 | To the extent the pre-negotiated purchaser will have to have any portion or all of its funds converted |
| | from one accepted form of currency to another accepted form of currency in order to for such funds |
| | to be deposited into the applicable escrow account (and/or as may otherwise be required by law), the |
| | pre-negotiated purchaser will be directed to transfer the funds to an affiliate of the Company (or an |
| | unrelated third party selected by the Company) who will facilitate the conversion of such funds and |
| | will then deposit the converted funds directly into the applicable broker escrow account. |
| 925 | Standard broker escrow account used in connection with the purchase and sale of securities. All |
| | interest of the escrowed funds, if any, will be: (a) paid to the security owner if/when the sale and |
| | transfer of the subject security is closed (see 990); (b) paid to the pre-negotiated purchaser if/when |
| | the sale and transfer of the subject security is terminated (1015). |
| 930 | The pre-negotiated purchaser will be directed to a secure area of the website and instructed to |
| | complete all necessary documents in order to legally evidence and effectuate the purchase and |
| | acceptance of the subject security from the security owner to the pre-negotiated purchaser. |
| | Document completion will be conducted through a secure and encrypted, web based, interface tool |
| | which will include, among other things, the ability to electronically sign the subject transfer |
| | documents (to the extent allowable under applicable law) and the encrypted electronic transfer of the |
| | final executed transfer documents to the secure document escrow database. To the extent any one or |
| | more of the transfer documents cannot be electronically signed by the pre-negotiated purchaser (as a |
| | result of applicable law or otherwise), the pre-negotiated purchaser will be instructed to (and how to) |
| | print and execute the applicable transfer documents and to deliver the executed physical documents |
| | to the Company to be held in escrow pending the closing or termination (as applicable) of the sale and |
| | transfer of the subject security by the security owner to the pre-negotiated purchaser. |
| 935 | The owner will be directed to a secure area of the website and instructed to complete all necessary |
| | documents in order to legally evidence and effectuate the transfer and sale of the subject security |
| | from the security owner to the pre-negotiated purchaser. Document completion will be conducted |
| | through a secure and encrypted, web based, interface tool which will include, among other things, the |
| | ability to electronically sign the subject transfer documents (to the extent allowable under applicable |
| | law) and the encrypted electronic transfer of the final executed transfer documents to the secure |
| | document escrow database. To the extent any one or more of the transfer documents cannot be |
| | electronically signed by the security owner (as a result of applicable law or otherwise), the security |
| | owner will be instructed to (and how to) print and execute the applicable transfer documents and to |
| | deliver the executed physical documents to the Company to be held in escrow pending the closing or |
| | termination (as applicable) of the sale and transfer of the subject security by the security owner to the |
| | pre-negotiated purchaser. |
| 940 | Once all of the executed transfer documents (and the original certificate evidencing the subject |
| | security, if any) have been delivered by the security owner and the pre-negotiated purchaser, the |
| | Company shall deliver copies of such documents (via a secure and encrypted, web based |
| | data/document transfer method) and/or original copies of such documents (to the extent required) to |
| | the applicable transfer agent of the issuing company/third party stock recording entity (as applicable). |
| 945 | Represents the issuing company/third party stock recording entity (as applicable). |
| 950 | The Company will oversee the execution/acknowledgment (as applicable) of all required transfer |
| | documents (if any), and the issuance and delivery of a replacement physical security (if any) in the |
| | name of the winning purchaser, by the issuing company and/or the applicable third party stock |
| | recording entity. |
| 955 | Represents the issuance and delivery of a replacement physical security (if any) in the name of the |
| | pre-negotiated purchaser. |
| 960 | Once all of the executed transfer documents (and the original replacement certificate evidencing the |
| | subject security, if any) have been delivered by the security owner, the pre-negotiated purchaser, and |
| | the issuing company and/or the applicable third party stock recording entity, copies of all documents |
| | will be delivered electronically to the document review department of the Company. |
| 965 | The applicable document review department of the Company. |
| 970 | If the document review department of the Company, after reviewing all received executed transfer |
| | documents, determines that all documents necessary to evidence the transfer of the subject security |
| | from the security owner to the pre-negotiated purchaser have been properly executed and received |
| | by the Company, the head of the document review department of the Company will authorize the |
| | simultaneous distribution of: (a) copies of all executed transfer documentation (including, without |
| | limitation, all transfer documentation evidencing the ownership of the subject security in the name of |
| | the pre-negotiated purchaser), and the replacement security (if any), from the document escrow to |
| | the pre-negotiated purchaser (975); (b) copies of all executed transfer documentation from the |
| | document escrow to the security owner (980); (c) the distribution of the escrowed funds (less the |
| | Company's transaction and other fees payable by the security owner) from the broker escrow account |
| | to the security owner (990); and (d) an amount equal to the Company's transaction and other fees |
| | payable by the security owner from the broker escrow account to the accounts payable department of |
| | the Company (995). The head of the document review department of the Company will also authorize |
| | an direct the Company's internal legal department (and/or outside counsel) to complete and file all |
| | necessary notice, compliance and related documents (if any) with the applicable governmental agency |
| | (1000) and deliver filed copies (to the extent received) of such documents to the security owner and |
| | the pre-negotiated purchaser. All document transfers from escrow will be done via encrypted |
| | electronic transfer to the extent possible subject to applicable law or otherwise. |
| 975 | Distribution of copies of all executed transfer documentation (including, without limitation, all transfer |
| | documentation evidencing the ownership of the subject security in the name of the pre-negotiated |
| | purchaser, and copies of any and all notice, compliance and related documents filed and received by |
| | the Company), and the replacement security (if any), from the document escrow to the pre-negotiated |
| | purchaser. |
| 980 | Distribution of copies of all executed transfer documentation (including, without limitation, copies of |
| | any and all notice, compliance and related documents filed and received by the Company) from the |
| | document escrow to the security owner. |
| 985 | To the extent the security owner has elected to receive the escrowed funds in an accepted form of |
| | currency other than the form of the escrowed funds, the escrow agent will be directed by the |
| | Company to transfer the escrowed funds to an affiliate of the Company (or an unrelated third party |
| | selected by the Company) who will facilitate the conversion of such funds and will then deposit the |
| | converted funds directly into the applicable deposit account selected by the security owner. |
| 990 | Distribution of the escrowed funds from the broker escrow account to the security owner via a direct |
| | wire, ACH transfer or other secured transfer of funds from the broker escrow account to the deposit |
| | account selected by the security owner. |
| 995 | Distribution of an amount equal to the Company's transaction and other fees payable by the security |
| | owner from the broker escrow account to the accounts payable department of the Company via a |
| | direct wire, ACH transfer or other secured transfer of funds from the broker escrow account to the |
| | deposit account selected by the accounts payable department of the Company. |
| 1000 | The Company's internal legal department (and/or outside counsel) will complete and file all necessary |
| | notice, compliance and related documents (if any) with the applicable governmental agency and |
| | deliver filed copies (to the extent received) of such documents to the security owner and the pre- |
| | negotiated purchaser. |
| 1005 | If the document review department of the Company, after reviewing all received executed transfer |
| | documents, determines that all documents necessary to evidence the transfer of the subject security |
| | from the security owner to the pre-negotiated purchaser have not (for whatever reason) been |
| | properly executed and received by the Company, and/or for whatever reason the transfer of the |
| | subject securities cannot be completed (including without limitation, as the result of any legal action) |
| | the head of the document review department of the Company will authorize the simultaneous |
| | distribution of: (a) the original physical security (if any), from the document escrow to the security |
| | owner (1010); and (b) the distribution (return) of the escrowed funds from the broker escrow account |
| | to the pre-negotiated purchaser (1015). |
| 1010 | The original physical security (if any). |
| 1015 | Distribution (return) of the escrowed funds from the broker escrow account to the pre-negotiated |
| | purchaser via a direct wire, ACH transfer or other secured transfer of funds from the broker escrow |
| | account to the deposit account selected by the pre-negotiated purchaser. |
| 1020 | If the document review department of the Company, after reviewing all received executed transfer |
| | documents, determines that all documents necessary to evidence the transfer of the subject security |
| | from the security owner to the pre-negotiated purchaser have not (for whatever reason) been |
| | properly executed and received by the Company, and/or for whatever reason the transfer of the |
| | subject securities cannot be completed (including without limitation, as the result of any legal action) |
| | the head of the document review department of the Company will cause the security owner to be |
| | notified and the security owner will be required to pay to the accounts payable department of the |
| | Company an amount equal to the minimum/termination fee established by the Company (if any). Such |
| | payment to be made via a direct wire, ACH transfer or other secured transfer of funds from the broker |
| | escrow account to the deposit account selected by the accounts payable department of the Company. |
| 1025 | Copies of any and all information submitted by (or on behalf of) the security owner and pre- |
| | negotiated purchaser, and copies of any and all transfer and other documentation pertaining to the |
| | purchase and sale of the subject security will be coded and stored electronically on an internal, |
| | secured, non-public database (515). Such information will be collected whether or not the subject sale |
| | has closed. |

In addition, there is provided a method for creating a secondary market for the auction based sale and transfer of: (i) any and all non-publically traded, private placed and/or restricted, securities, debt instruments and other financial derivatives; (ii) individual and/or portfolios of performing and non-performing loans and other debt instruments; and/or (iii) other securitized assets; in the U.S. and worldwide, the method comprising of (purchaser-side transactions): receiving of detailed profile information of each prospective purchaser; an automated, computer based, determination that the each prospective purchaser passes a pre-screening qualification test based on applicable law and other predetermined anti-fraud criteria; registering fully verified prospective purchasers in a secure, non- and restricted access computer database, and assigning specific internal investor classifications to each verified purchaser; limiting each prospective purchaser's access to offering information based on such prospective purchaser's internal investor classification; facilitating a prospective purchaser's electronic based sorting of available offerings based on specific inputted criteria selected by purchaser; facilitating the secure, and anonymous, bidding by each qualified prospective purchaser over an electronic platform; documenting the transfer of sold securities from security owner to winning purchaser, including coordination with, and confirmation by, issuer; escrowing the secure transfer of funds from winning purchaser to security owner; escrowing the secure transfer of physical securities (as applicable) from security owner to winning purchaser; recording pertinent sale information in secure, non-public, computer database for record keeping; receiving and recording, (at the option of purchaser), notice criteria for future offerings.

In addition, the method further comprising of the automated initial pre-screening of potential purchasers based on applicable law, including: identification of prospective purchaser Internet Protocol (IP) address both initially and at the point of each login to the portal; creation of a secure, method for the uploading of due diligence information regarding the pre-screening and/or classification of prospective purchaser; storage of uploaded prospective purchaser due diligence information in secure, non-public, computer database, to the extent required by applicable law.

In addition, the method further comprising the ongoing and periodic verification of purchaser criteria and respective internal investor classification; In addition, the method further comprising the direct and secure transfer of: funds from the wining purchaser into an established escrow account; upon completion of the sale and verification process, funds from the escrow fund to security owner and the company (for the payment of fees); and upon termination of the sale and/or failure of the verification process, funds from the escrow fund back to pre-negotiated purchaser.

In addition, the method further comprising facilitating the acceptance of multiple types of globally accepted currencies and the exchange, at point of auction closing, of winning purchaser provided currency to security owner preferred currency, including: acceptance of European and Canadian currencies Bitcoin; litecoin and related currencies; the direct and secure transfer of exchanged funds into the escrow account.

In addition, the method further comprising facilitating the exchange, at point of return of funds upon an auction failing, of form of escrow funds to purchaser requested form of currency, including: exchange to European and Canadian currencies Bitcoin, Litecoin, and related currencies; and the direct and secure transfer of exchanged funds from the escrow account to purchaser directed account.

In addition, the method further comprising the completion and filing of all necessary compliance related materials related to the transfer and sale of securities to, and the acceptance of monies from, foreign investors.

In addition, the method further comprising (at the option of purchaser) providing notice to qualified purchasers, via one or more over electronic networks, of offerings based on purchaser selected notice criteria but subject to purchaser's internal investor classification.

In yet another method for facilitating the pre-negotiated sale and transfer of: (i) any and all non-publically traded, private placed and/or restricted, securities, debt instruments and other financial derivatives; (ii) individual and/or portfolios of performing and non-performing loans and other debt instruments; and/or (iii) other securitized assets; in the U.S. and worldwide; from a willing security owner to a willing buyer, the method comprising of (sale-side transactions): receiving of detailed registration information of selling security owner; receiving of detailed profile information of pre-negotiated purchaser; an automated, computer based, determination that the security owner passes a pre-screening qualification test based on applicable law and other predetermined anti-fraud criteria; receiving of detailed information regarding the per-negotiated sale of the subject security(ies) for sale, including without limitation: the name of issuer, contact information for issuer, date of acquisition, name of pre-negotiated purchaser, contact information of pre-negotiated purchaser, and purchase price; registering the pre-screened securities in an initial secure, non-public, computer database until completion of human verification of all applicable owner, issuer, and security information; registering fully verified securities in a separate, secure, and restricted access computer database; facilitating the pre-negotiated transfer and sale of fully verified securities over an electronic platform; creating and maintaining a secure, non-public, data platform for the uploading and data transfer between security owner and pre-negotiated purchaser of, and access of security owner and pre-negotiated purchaser to, confidential information regarding the “for sale” security; restricting access to transfer and sale data platform information only to security owner and pre-negotiated purchaser; documenting the transfer of sold securities from security owner to pre-negotiated purchaser; including coordination with, and confirmation by, issuer; escrowing the secure transfer of funds from pre-negotiated purchaser to security owner; escrowing the secure transfer of physical securities (as applicable) from security owner to pre-negotiated purchaser; recording pertinent sale information in secure, non-public, computer database for record keeping.

In addition, the method further comprising of the pre-negotiated sale and transfer of, without limitation, performing and un-performing debt instruments, structured payment settlement and other annuities, limited partnership interests, interests in real estate (including, without limitation, tenant in common interests and interests in land trusts), options with respect to the purchase of any non-publically traded, private placed and/or restricted, securities, debt instruments and other financial derivatives, life insurance policies/proceeds, and assets securitized by one or more non-publically traded, private placed and/or restricted, securities, debt instruments and other financial derivatives.

In addition, the method further comprising of the: creation of a secure, method for the uploading of due diligence information regarding the pre-negotiated purchaser; and storage of uploaded pre-negotiated purchaser due diligence information in secure, non-public, computer database, to the extent required by applicable law.

In addition, the method further comprising of providing for the secure uploading and data transfer of initial confidential information from security owner to portal regarding the security owner and the security.

In addition, the method further comprising, as part of the human verification process, of the review of all related due diligence materials.

The secondary pre-screening of “for sale” based on verification of issuer and security information against internal offering record database and other predetermined anti-fraud criteria; creation of secure data platforms for the uploading and data transfer between security owner and portal of, and access of security owner and portal to, due diligence information regarding the “for sale” security and the issuer;

In addition, the method further comprising of preparing all required offering materials and notice filings, if any, in accordance with applicable law:

In addition, the method further comprising of restricting access to transfer and sale website data platform information only to: security owner, with limited access to delete or edit information once posted; the pre-negotiated purchaser, with limited access to view and print information and no access to modify information; and necessary employees of the portal, with limited access to view, print and delete information.

In addition, the method further comprising establishing and maintaining. a secure, internet based, point of communication between pre-negotiated purchaser and the security owner.

In addition, the method further comprising the direct and secure transfer of: funds from the pre-negotiated purchaser into an established escrow account; upon completion of the sale and verification process, funds from the escrow fund to security owner and the company (for the payment of fees); and upon termination of the sale and/or failure of the verification process, funds from the escrow fund back to pre-negotiated purchaser.

In addition, the method further comprising facilitating the acceptance of multiple types of globally accepted currencies and the exchange, at point of auction closing, of pre-negotiated purchaser provided currency to security owner preferred currency, including: acceptance of European and Canadian currencies Bitcoin. Litecoin, and related currencies; and the direct and secure transfer of exchanged funds into the escrow account.

In addition, the method further comprising the completion and filing of all necessary compliance related materials related to the transfer and sale of securities to, and the acceptance of monies from, foreign investors.

In addition, the method further comprising of charging the security owner of the given security a flat transaction fee or transaction fee based on a percentage of the final sale price of the security: registering of portal as a “broker dealer,” or the equivalent (as applicable), in all jurisdictions where such registration is required; and continuing compliance with all applicable laws in order to maintain such registration.

In addition, the method further comprising of the collecting and recording of applicable sale information including, without limitation: issuer information; industry information; issuer contact information; final sale price; security type, charging the security owner of the given security a transaction fee based on a percentage of the final sale price of the security.

In addition, the method further comprising of the collecting and recording of applicable sale information.

In addition, the method further comprising the back end integration with industry securities record keeping platforms and related platforms and the secure transfer of information to and from such third-party platforms.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended drawings provided, all such modifications within the scope of the invention.

I claim:

1. A method for creating a secondary market for the auction based sale and transfer of: (i) any and all non-publically traded, private placed and/or restricted, securities, debt instruments and other financial derivatives; (ii) individual and/or portfolios of performing and non-performing loans and other debt instruments; and/or (iii) other securitized assets; in the U.S. and worldwide, the method comprising of (sale-side transactions):
receiving of detailed registration information of selling security owner;
an automated, computer based, determination that the security owner passes a pre-screening qualification test based on applicable law and other predetermined anti-fraud criteria;
receiving of detailed information regarding securities for sale, including without limitation: the name of issuer, contact information for issuer, date of acquisition;
an automated, computer based, determination that the subject security passes each of the multi-tiered pre-screening tests based on applicable law and other predetermined anti-fraud criteria;
registering the pre-screened securities in an initial secure, non-public, computer database until completion of human verification of all applicable owner, issuer, and security information;
registering fully verified securities in a separate, secure, and restricted access computer database;
receiving, by security owner, of optional “pre-auction” acquisition offer for fully verified securities from company affiliated investment fund;
facilitating the offer and sale of fully verified securities over an electronic platform through purchaser restricted, timed, auctions;
pre-screening of purchasers based on applicable law and other predetermined anti-fraud criteria;
creating and maintaining secure data platforms for the uploading and data transfer between security owner and qualifying auction purchasers of, and access of security owner and qualifying auction purchasers to, confidential information regarding the “for sale” security;
restricting access to auction data platform information only to qualifying persons;
facilitating the secure, and anonymous, bidding by qualified purchasers over an electronic platform;
documenting the transfer of sold securities from security owner to winning purchaser, including coordination with, and confirmation by, issuer;
escrowing the secure transfer of funds from winning purchaser to security owner;
escrowing the secure transfer of physical securities (as applicable) from security owner to winning purchaser;
recording pertinent sale information in secure, non-public, computer database for record keeping.

2. The method of claim 1, further comprising of the auction based sale and transfer of, without limitation, performing and un-performing debt instruments, structured payment settlement and other annuities, limited partnership interests, interests in real estate (including, without limitation, tenant in common interests and interests in land trusts), options with respect to the purchase of any non-publically traded, private placed and/or restricted, securities, debt instruments and other financial derivatives, life insurance policies/proceeds, and assets securitized by one or more non-publically traded, private placed and/or restricted, securities, debt instruments and other financial derivatives.

3. The method of claim 1, further comprising of:
creation of a secure, method for the uploading of due diligence information regarding the security owner and the security;
storage of uploaded security owner/security due diligence information in secure, non-public, computer database, to the extent required by applicable law.

4. The method of claim 1, further comprising of the automated initial pre-screening of “for sale” securities based on applicable statutory holding period (if any) and other transfer restrictions.

5. The method of claim 1, further comprising the automated secondary pre-screening of “for sale” based on verification of issuer and security information against internal offering record database and other predetermined anti-fraud criteria.

6. The method of claim 1, further comprising, as part of the human verification process, of the review of all related due diligence materials.

7. The method of claim 1 wherein secondary pre-screening of “for sale” based on verification of issuer and security information against internal offering record database and other predetermined anti-fraud criteria;
creation of secure data platforms for the uploading and data transfer between security owner and portal of, and access of security owner and portal to, due diligence information regarding the “for sale” security and the issuer.

8. The method of claim 1, further comprising of preparing all required offering materials and notice filings, if any, in accordance with applicable law.

9. The method of claim 1, further comprising of offering ancillary, fee-based, services in connection with the online presentation and advertising of offering related materials, including, without limitation, the preparation of audio and/or visual materials in connection therewith.

10. The method of claim 1, further comprising of offering ancillary, fee-based, services in connection with estimating the approximate fair market value of the “for sale” security.

11. The method of claim 1, further comprising of restricting access to auction data platform information only to:
security owner, with limited access to delete or edit information once posted;
vetted and qualified purchasers, with limited access to view and print information and no access to modify information;
necessary employees of the portal, with limited access to view, print and delete information; and
to the extent security owner has elected to receive a “pre-auction” acquisition offer, necessary employees of the investment fund with limited access to view and print information and no access to modify information.

12. The method of claim 1, further comprising of restricting access of prospective purchasers to auction data platform information based on respective internal investor classification (discussed in claim 2), respective purchaser Internet Protocol (IP) address (as applicable), and other restrictions based on applicable law.

13. The method of claim 1, further comprising establishing and maintaining, a secure, internet based, point of communication:
between qualified purchasers and the security owner, wherein all communication is made viewable to all qualified purchasers;
wherein qualified purchases can communicate with each other and all communication is made viewable to all qualified purchasers.

14. The method of claim 1, further comprising the direct and secure transfer of:
funds from the winning purchaser into an established escrow account;
upon completion of the sale and verification process, funds from the escrow fund to security owner and the company (for the payment of fees); and
upon termination of the sale and/or failure of the verification process, funds from the escrow fund back to winning purchaser.

15. The method of claim 1, further comprising facilitating the acceptance of multiple types of globally accepted currencies and the exchange, at point of auction closing, of purchaser provided currency to security owner preferred currency, including:
acceptance of European and Canadian currencies Bitcoin. Litecoin, and related currencies;
the direct and secure transfer of exchanged funds into the escrow account.

16. The method of claim 1, further comprising the completion and filing of all necessary compliance related materials related to the transfer and sale of securities to, and the acceptance of monies from, foreign investors.

17. The method of claim 1, further comprising of charging the security owner of the given security a transaction fee based on a percentage of the final sale price of the security;
registering of portal as a “broker dealer,” or the equivalent (as applicable), in all jurisdictions where such registration is required;
continuing compliance with all applicable laws in order to maintain such registration.

18. The method of claim 1, further comprising of the collecting and recording of applicable sale information including, without limitation:
issuer information,
industry information;
issuer contact information;
final sale price;
security type, charging the security owner of the given security a transaction fee based on a percentage of the final sale price of the security.

19. The method of claim 1, further comprising of the collecting and recording of applicable sale information.

20. The method of claim 1, further comprising the back end integration with industry securities record keeping platforms and related platforms and the secure transfer of information to and from such third-party platforms.
